(19) United States
(12) Patent Application Publication
(10) Pub. No.: US 2026/0203148 A1
(43) Pub. Date: Jul. 16, 2026

(54) ANOMALY CHARACTERIZATION USING SNAPSHOTS

(71) Applicant: Rubrik, Inc., Palo Alto, CA (US)

(72) Inventors: Jaya Jyothiswaroop Kotni, Bengaluru (IN); Sayantan Jana, Palo Alto, CA (US); Yashashavi Momyan, Bengaluru (IN); Vinita Sharma, Bengaluru (IN); Chaitanya Choudhary Nettem, Bengaluru (IN)

(21) Appl. No.: 19/023,140

(22) Filed: Jan. 15, 2025

(51) Int. Cl. G06F 11/00

(52) U.S. Cl. CPC G06F 11/004; G06F 2201/80

(57) ABSTRACT

Methods, systems, and devices for data management are described. An anomaly in data of a computing system that includes multiple computing objects may be detected based on an analysis of snapshots of the computing objects. Based on detecting the anomaly, first data associated with a first snapshot of a first computing object of the computing objects may be compared with second data associated with a second snapshot of a second computing object of the computing objects. Based on comparing the first data with the second data, whether the anomaly is associated with undesirable activity in the computing system may be determined.

### FIELD OF TECHNOLOGY

The present disclosure relates generally to data management, including techniques for anomaly characterization using snapshots.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports anomaly characterization using snapshots in accordance with aspects of the present disclosure.

FIG. 2 shows an example of a set of operations for anomaly characterization using snapshots in accordance with aspects of the present disclosure.

FIGS. 3A and 3B show an example of a diagram for anomaly characterization using snapshots in accordance with aspects of the present disclosure.

FIG. 4 shows an example of a diagram for anomaly characterization using snapshots in accordance with aspects of the present disclosure.

FIGS. 5A and 5B show an example of a diagram for anomaly characterization using snapshots in accordance with aspects of the present disclosure.

FIG. 6 shows a block diagram of an apparatus that supports anomaly characterization using snapshots in accordance with aspects of the present disclosure.

FIG. 7 shows a block diagram of a data manager that supports anomaly characterization using snapshots in accordance with aspects of the present disclosure.

FIG. 8 shows a diagram of a system including a device that supports anomaly characterization using snapshots in accordance with aspects of the present disclosure.

FIG. 9 shows a flowchart illustrating methods that support anomaly characterization using snapshots in accordance with aspects of the present disclosure.

### DETAILED DESCRIPTION

A data management system may execute an anomaly detection procedure, which may read metadata in snapshots to identify anomalies in data of a computing system with low-latency. The data management system may also perform an encryption detection procedure, which may read the content of the underlying data associated with the anomaly. The result of the encryption detection procedure may indicate whether the detected anomaly is actually associated with undesirable behavior or is instead a “false positive” associated with desirable behavior.

Time is critical in the event of a malware or ransomware attack. Accordingly, in some examples, an anomaly-detected alert is sent based on a result of the metadata-based and lower-latency anomaly detection procedure—and before the data management system completes the encryption detection procedure—to reduce a latency for reporting detected anomalies. This may, however, lead to some alerts being based on false positives. And although allowing the encryption detection procedure to be executed (at least partially or completely) before sending the alert may allow the anomaly detection procedure to avoid sending alerts that are later confirmed by the encryption detection procedure to be false positives, a conventional encryption detection procedure may be associated with an undesirable amount of latency, processing overhead, or both. Moreover, certain desirable operations (e.g., upgrade procedures) may trigger a significant quantity of false positives by the anomaly detection procedure, which may result in a significant quantity of unnecessary alerts being sent to the customer, unnecessary processing resource utilization, or both. Thus, implementations that support reducing the quantity of unnecessary anomaly-detected alerts sent to a customer and the amount of unnecessary processor utilization while maintaining low-latency reporting may be desired.

To reduce the quantity of unnecessary anomaly-detected alerts sent to a customer, the amount of unnecessary processor utilization, or both, while maintaining low-latency reporting capabilities, the undesirable-behavior detection service may be configured to include a false positive detection procedure that compares (e.g., after an anomaly detection procedure within a processing flow) data associated with snapshots for different computing objects at a customer's computing system with one another to identify whether anomalous file system changes are associated with desirable behavior or undesirable behavior. In some examples, the different computing objects may be of a same or similar type. To further reduce a latency associated with the false positive detection procedure, minhashes may be used to compare data associated with different snapshots.

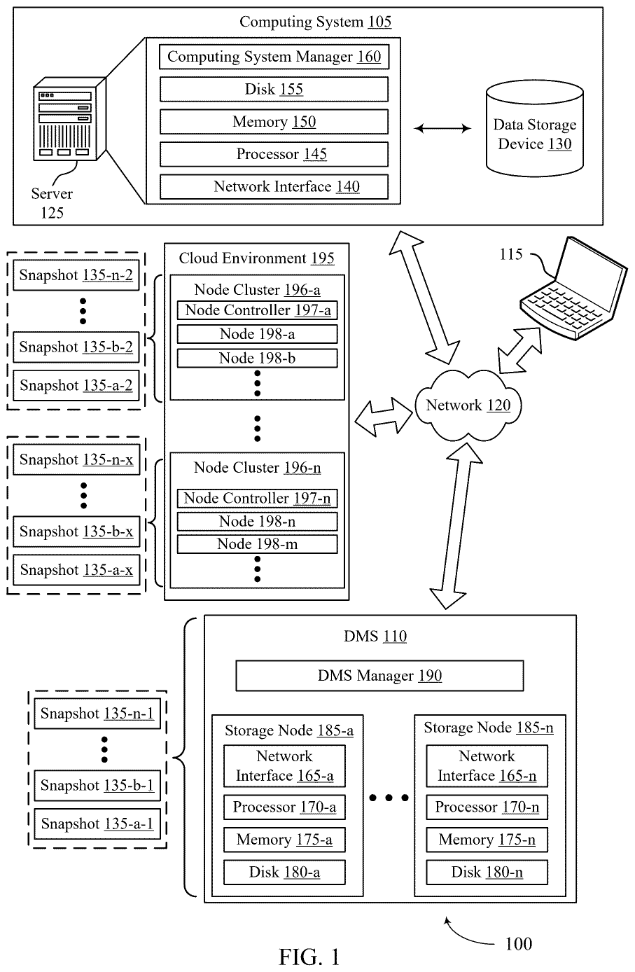

FIG. 1 illustrates an example of a computing environment 100 that supports anomaly characterization using snapshots in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. In some cases, a computing object that is the subject of a snapshot 135 may be or include a collection of multiple objects (e.g., computing objects may have hierarchical relationships, with lower-level computing objects included within one or more higher-level computing objects). For example, a filesystem may include multiple files, and along with the filesystem being a computing object, the files therein may also be computing objects. Or, as another example, a database may include multiple tables, and along with the database being a computing object, the tables therein may also be computing objects. Thus, a snapshot may be of one or more computing objects, and a snapshot of a first computing object (e.g., a higher-level computing object) may also be a snapshot of each computing object (e.g., each lower-level computing object) that is included in (e.g., is a member or component of) the first computing object. Additionally, a snapshot may be of one or more lower-level computing objects individually (e.g., a snapshot of a lower-level computing object may be separate from another snapshot of another lower-level computing object, separate from another snapshot of a higher-level computing object that contains the lower-level computing object, or both).

A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. A base snapshot 135 may alternatively be referred to as a full snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a base snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a base snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant's data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

A computing system may include multiple computing objects. In some examples, each of the multiple computing objects in the computing system is associated with one or more computing object types. For example, a computing object may be a physical machine (PM), a virtual machine (VM), a database, a server, a node of a server cluster, a container, or the like. In some examples, similar operating systems may be installed on computing objects of a common type. For example, the computing objects may include physical machines (PMs) running a Windows® operating system, one or more VMs running a Linux® operating system, one or more VMs running a Windows® operating system, one or more databases running an Oracle® operating system, one or more servers running a Linux® operating system, one or more nodes running a Linux® operating system, one or more containers running a same operating system, and the like.

A computing system may be frequently updated—e.g., to address security concerns, to address flaws, to add new features, etc. In some examples, upgrades in a computing system may be applied concurrently (e.g., at a same time, within hours of one another, etc.) across multiple similarly-typed computing objects—e.g., to maintain operational and managerial consistency across similarly-typed computing objects in the computing system. For example, an update procedure may be concurrently performed for a portion (e.g., all) of the physical machines running a Windows® operating system.

A data management system may provide an undesirable-behavior detection service that is used to identify behavior in a computing system that is indicative of undesirable activity (e.g., unintentional mass deletion, mass addition, or mass modification; intended, but unauthorized mass deletion, mass addition, or mass modification; malware activity; ransomware activity; etc.). In some examples, the undesirable-behavior detection service may include an anomaly detection procedure that is configured to analyze changes in respective file systems of one or more of a customer's computing objects that are protected by the data management system. For example, the anomaly detection procedure may detect anomalies by analyzing additions, modifications, and/or deletions to files in a file system of a computing object that occur between two points-in-time—e.g., an anomaly may be detected if a threshold quantity of additions, modifications, and/or deletions are made within two points-in-time. After an anomaly is detected in a customer's computing system, the anomaly detection system may be configured to send an alert to the customer.

As described herein, a data management system may take snapshots of computing objects in a customer's computing system, where the snapshots may represent a state of the computing objects (e.g., a state of file systems of the computing objects) at different points-in-time. In some examples, the snapshots are included in a snapshot chain that includes a base (full) snapshot and one or more incremental snapshots, one or more differential snapshots, or both. Incremental snapshots may represent changes to the state of a computing object relative to a preceding snapshot. Differential snapshots may represent changes to the state of a computing object relative to a base snapshot. Thus, in some examples, incremental and differential snapshots of a computing object may be analyzed with low latency (due to their reduced size relative to full snapshots) to detect changes in the state of a computing object. In some examples, the anomaly detection procedure may use file system metadata associated with a snapshot (e.g., stored in a snapshot file for the snapshot) to detect changes in the state of the computing object, which may further reduce the amount of data to be processed and the time for detecting anomalies.

The undesirable-behavior detection service may also include an encryption detection procedure that is configured to read the underlying content associated with a detected anomaly and to determine whether the underlying content has been encrypted. The encryption detection procedure may include calculating an entropy of the underlying content and inputting the results to an encryption detection model. In some examples, a result of the encryption detection procedure may confirm whether a detected anomaly is a result of a ransomware attack. The encryption detection procedure may take a significant amount of time and may utilize a significant amount of processing resources (e.g., relative to the time and processing resources for completing the anomaly detection procedure).

In some examples, the anomaly detection process detects anomalies that are associated with desirable behavior. Such anomalies may be referred to as false positives. Certain operations at a customer's computing system may be more likely to trigger the generation of false positive anomaly alerts than other operations. For example, upgrades of a computing system may result in a large quantity of files at the computing system being changed in a short amount of time (e.g., between two points-in-time associated with adjacent snapshots), which may trigger the anomaly detection procedure to detect an anomaly in the customer's computing system. In some examples, such operations may frequently occur (e.g., on a daily basis, on a weekly basis) and may provide a basis for a significant quantity of false positives.

Time is critical in the event of a malware or ransomware attack. Accordingly, in some examples, an anomaly-detected alert is sent based on a result of the metadata-based and lower-latency anomaly detection procedure—and before the data management system completes (or, in some examples, before or concurrently with the data management system initiating) the encryption detection procedure—to reduce a latency for reporting detected anomalies. This may, however, lead to some alerts being based on false positives. And although allowing the encryption detection procedure to be executed (at least partially or completely) before sending the alert may allow the anomaly detection procedure to avoid sending alerts that are later confirmed by the encryption detection procedure to be false positives, a conventional encryption detection procedure may be associated with an undesirable amount of latency, processing overhead, or both. Moreover, certain desirable operations (e.g., upgrade procedures) may trigger a significant quantity of false positives by the anomaly detection procedure, which may result in a significant quantity of unnecessary alerts being sent to the customer, unnecessary processing resource utilization, or both. Thus, implementations (e.g., methods, systems, apparatuses, techniques, configurations, components) that support reducing the quantity of unnecessary anomaly-detected alerts sent to a customer and the amount of unnecessary processor utilization while maintaining low-latency reporting may be desired.

To reduce the quantity of unnecessary anomaly-detected alerts sent to a customer, the amount of unnecessary processor utilization, or both, while maintaining low-latency reporting capabilities, the undesirable-behavior detection service may be configured to include a false positive detection procedure that compares (e.g., after an anomaly detection procedure within a processing flow) data associated with snapshots for different computing objects at a customer's computing system with one another to identify whether anomalous file system changes are associated with desirable behavior (e.g., an upgrade procedure) or undesirable behavior (e.g., unintentional mass deletion, addition or modification; intended, but unauthorized mass deletion, addition, or modification; malware activity; ransomware activity; etc.). In some examples, the different computing objects may be of a same type (e.g., multiple VMs running a common operating system) or a similar type (e.g., one or more VMs of a first type, such as one or more VMware® VMs, and one or more VMs of a second type, such as one or more Nutanix® VMs). To further reduce a latency associated with the false positive detection procedure, minhashes may be used to compare data associated with different snapshots.

In some examples, a DMS (e.g., the DMS 110) may detect an anomaly in data of a computing system (e.g., the computing system 105), which may include multiple computing objects. The multiple computing objects may include one or more computing objects of one or more types. In some examples, the detected anomaly may be associated with a threshold quantity of files being added, modified, or deleted in one or more computing objects of the computing system. The file system changes may be attributable to desirable behavior or undesirable behavior within the computing system. However, in some examples, the DMS may not distinguish the type of behavior when the anomaly is initially detected.

Based on detecting the anomaly, the DMS may compare first data associated with a snapshot (e.g., first hashes or minhashes of data associated with the file system metadata, first file system metadata associated with a snapshot) of one computing object of the computing system with data associated with one or more snapshots of one or more other computing objects of the computing system. In some examples, the computing object may be compared with one or more computing objects that are of a same or similar type as the computing object—e.g., computing object and the one or more computing objects may be PMs running a same operating system, VMs running a same operating system, servers running a same operating system, nodes of a server cluster, containers running a same operating system, etc.

Based on comparing the data associated with the snapshots, the DMS may determine whether the anomaly is associated with desirable activity or undesirable activity within the computing system. In some examples, the DMS may determine that the anomaly is associated with desirable activity if the first data is sufficiently similar (e.g., have a similarity score that is greater than a threshold) to data associated with at least one of the one or more other computing objects. In such cases, the DMS may refrain from sending an alert to a customer that manages the computing system that the anomaly has been detected. In some examples, the desirable activity is an upgrade procedure that is executed concurrently across multiple similarly-typed computing objects in the computing system.

In other examples, the DMS may determine that the anomaly may be associated with undesirable activity if the first data is insufficiently similar (e.g., have a similarity score that is less than a threshold) to the data associated with the one or more other computing objects. In such cases, the DMS may send an alert to the customer that the anomaly has been detected. In some examples, the comparison and determination may be completed before the DMS is able to complete the execution of an encryption detection procedure.

By comparing the data of snapshots across multiple computing objects, an anomaly identified for a computing system may be identified as being associated with desirable behavior (e.g., an upgrade procedure) before an anomaly-detected alert is sent to the customer. Thus, an unnecessary anomaly-detected alert may be prevented from being sent to a customer, which may improve an experience of the customer. Also, in some examples, the data management system may refrain from performing a resource intensive encryption detection procedure, which may preserve computing resources at the data management system and improve an average performance of the data management system.

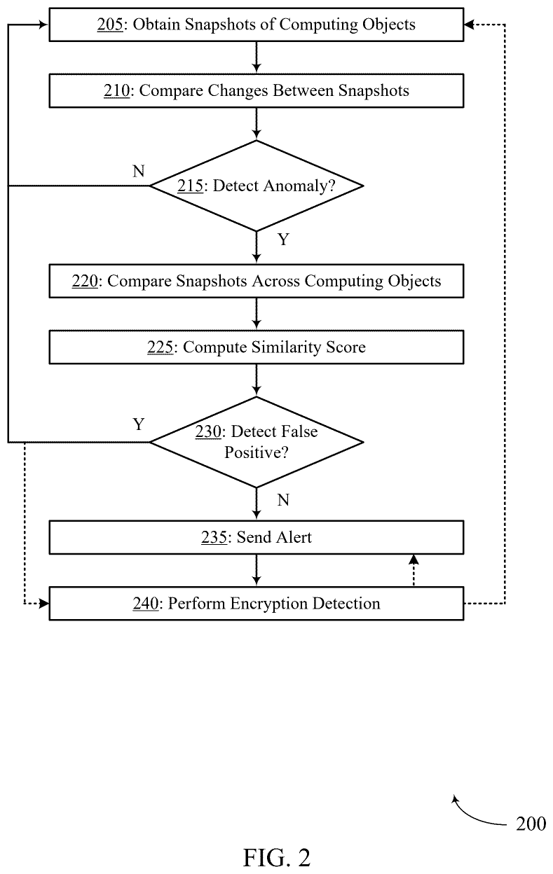

FIG. 2 shows an example of a set of operations for anomaly characterization using snapshots in accordance with examples as disclosed herein.

The flowchart 200 may be performed by a DMS (such as the DMS 110 of FIG. 1). In some examples, the flowchart 200 shows an example set of operations performed to support anomaly characterization using snapshots. For example, the flowchart 200 may include operations for identifying anomalies that are associated with false positives.

At 205, snapshots of a set of computing objects may be obtained. In some examples, a full snapshot and a set of incremental snapshots, a set of differential snapshots, or both may be obtained for each computing object of the set of computing objects. The set of computing objects may be included in a computing system. In some examples, the set of computing objects may include different computing object types (e.g., physical machines, virtual machines, containers, servers, server nodes, network attached storages, databases, etc.). In some examples, at least a portion of the computing objects of one computing object type may run similar, or the same, system-level software.

At 210, snapshots for the computing objects may be analyzed to identify changes to the computing objects that occur between two points-in-time. In some examples, each new snapshot taken for each computing object may be analyzed for changes.

In some examples, metadata associated with an incremental snapshot taken of a computing object at a first point-in-time may be analyzed to identify the changes to the computing object (e.g., files that were added, modified (at a content level, at a permission level, etc.), deleted, etc.) since a last snapshot was taken of the computing object at a second, earlier point-in-time—e.g., because the incremental snapshot may only capture changes since the last snapshot. In some examples, the two-points in time correspond to two consecutive snapshots of the computing object.

In some examples, metadata associated with a first differential snapshot taken of a computing object at a first point-in-time and metadata associated with a second differential snapshot taken of the computing object at a second, earlier point-in-time may be analyzed to determine the changes to the computing object since the second differential snapshot was taken—e.g., by identifying changes indicated by the metadata associated with the first differential snapshot that are different than changes indicated by the metadata associated with the second differential snapshot. In some examples, the two-points in time correspond to two consecutive snapshots of the computing object.

At 215, an anomaly detection operation for checking the snapshots of the computing objects for anomalies may be executed. In some examples, each new snapshot that is generated for each computing object may be checked for anomalies. In some examples, the anomaly detection operation may not detect any anomalous behavior based on the metadata associated with the snapshots. In such cases, the DMS may continue to obtain and analyze new snapshots of the computing object until an anomaly is detected.

In other examples, the anomaly detection operation may detect anomalous behavior based on metadata associated with the snapshot—e.g., based on detecting that a threshold quantity of files were modified, deleted, or both, in the computing object; based on detecting that permissions were changed for a threshold quantity of files; or based on other heuristics for identifying anomalous behavior using metadata. In some examples, the anomalous behavior is attributable to desirable behavior within the computing system—e.g., an upgrade of the computing object. In other examples, the anomalous behavior is attributable to undesirable behavior within the computing system—e.g., a ransomware attack. Though providing low-latency anomaly detection, the metadata analyzed by the anomaly detection operation in a single snapshot may not provide the data management DMS with sufficient information to distinguish between anomalous behavior caused by desirable or undesirable behavior without also analyzing the underlying content (e.g., the user data) associated with the snapshot. Accordingly, the anomaly detection operation may detect a significant quantity of anomalies that are false positives—e.g., anomalies that are actually associated with desirable behavior.

At 220, snapshots may be compared across computing objects based on an anomaly being detected in one or more snapshots of the computing system. For example, first data associated with a first snapshot (e.g., the most recent snapshot) for a first computing object (e.g., first data that has changed at the first computing object) may be compared with second data associated with a second snapshot (e.g., the most recent snapshot) for a second computing object (e.g., second data that has changed at the second computing object). In some examples, the first snapshot for the first computing object may have been flagged as anomalous during the anomaly detection operation, the second snapshot for the second computing object may have been flagged as anomalous during the anomaly detection operation, or both. In some examples, the first data associated with the first snapshot may be compared with respective data associated with respective snapshots of multiple (e.g., each) of the computing objects in the computing system.

In some examples, first hashes for first user data associated with the first snapshot for the first computing object may be compared with second hashes for second user data associated with the second snapshot for the second computing object. In some examples, a location of the first user data may be indicated by first metadata in a first snapshot file for the first snapshot, and a location of the second user data may be indicated by second metadata in a second snapshot file for the second snapshot. In some examples, the first hashes for the first user data are stored in the first metadata associated with the first snapshot, and the second hashes for the second user data are stored in the second metadata associated with the second snapshot. In some cases, the hashes are computed and stored in the metadata in advance of the anomaly detection operation—e.g., the hashes may be computed and stored when the snapshots of the computing objects are taken. In some examples, the hashes are computed to support additional services supported by the DMS, such as a deduplication service. In some cases, the hashes are computed and stored after an anomaly is detected.

In some examples, first minhashes for first user data associated with the first snapshot for the first computing object may be compared with second minhashes for second user data associated with the second snapshot for the second computing object. In some examples, the first minhashes are derived from the first hashes for the first user data. For example, the first minhashes may be a subset of the first hashes—e.g., a first quantity of the first hashes with the lowest values, such as the hundred lowest hashes of the first hashes. The second minhashes may be similarly derived from the second hashes for the second user data.

In some examples, first metadata associated with the first snapshot for the first computing object is compared with second metadata associated with the snapshot for a second computing object. In some examples, the first metadata is file system metadata that indicates filenames for the files associated with the first snapshot—e.g., the files that have been added, modified, or deleted since the last snapshot of the first computing object. In some examples, the second metadata is file system metadata that indicates filenames for the files associated with the second snapshot—e.g., the files that have been added, modified, or deleted since the last snapshot of the second computing object.

In some examples, a comparison of the file system metadata associated with the different snapshots for the different computing objects may indicate whether similar data was changed in both snapshots. For example, if the filenames indicated in the first file system metadata are sufficiently similar to the filenames indicated in the second file system metadata (e.g., enough of the same filenames are indicated), this may indicate that an upgrade procedure was applied to both of the computing objects—e.g., because a same upgrade procedure may apply the same or similar changes to separate computing objects.

At 225, similarity scores between the different snapshots may be computed. In some examples, the similarity score may be based on a Jaccard similarity. In some examples, the similarity score may be obtained by computing the following equation:

$$\frac{Size ( Set ( A ⋂ B ) )}{Size ( Set ( A ⋃ B ) )} .$$

In some examples, set A is equal to the first hashes associated with the first snapshot for the first computing object, and set B is equal to the second hashes associated with the second snapshot for the second computing object. In some examples, the Jaccard similarity algorithm yields a similarity score that is greater than a similarity score threshold—e.g., which may indicate that first hashes are similar enough to the second hashes to indicate desirable activity in the computing system. In some examples, the similarity score threshold is greater than 0.2. In some examples, the Jaccard similarity algorithm yields a similarity score that is less than a similarity score threshold—e.g., which may indicate that first hashes are not similar enough to the second hashes, which may indicate undesirable activity in the computing system.

In some examples, set A is equal to the first minhashes associated with the first snapshot for the first computing object, and set B is equal to the second minhashes associated with the second snapshot for the second computing object. Using minhashes may reduce the processing load associated with comparing the similarity of snapshots across a large quantity of snapshots for a large quantity of computing objects.

In some examples, set A is equal to the first filenames (or numeric representations thereof) associated with the first snapshot, and set B is equal to the second filenames (or numeric representations thereof) associated with the second snapshot.

At 230, a false positive detection operation for determining whether the detected anomaly (e.g., in a flagged snapshot) is associated with a false positive may be executed. In some examples, the false positive detection operation may compare the computed similarity score with the similarity score threshold.

In some examples, the similarity score is greater than or equal to the similarity score threshold, and it may be determined that the anomaly is associated with a false positive. In such cases, the procedure may refrain from executing both an alerting operation and an encryption detection procedure and return to obtaining and analyzing snapshots. Skipping the alerting operation may reduce a quantity of unnecessary alerts sent to a customer. Skipping the encryption detection procedure (when a false positive is detected) may significantly reduce a processing burden of the anomaly detection pipeline. In some examples, the procedure may may skip the alerting operation but perform the encryption detection procedure—e.g., as a second layer for confirming the anomaly is a false positive.

In some examples, the similarity score is less than the similarity score threshold, and it may be determined that the anomaly is associated with an actual anomaly for which further investigation and possible action is recommended. In such cases, the procedure may proceed to send an alert that an anomaly was detected.

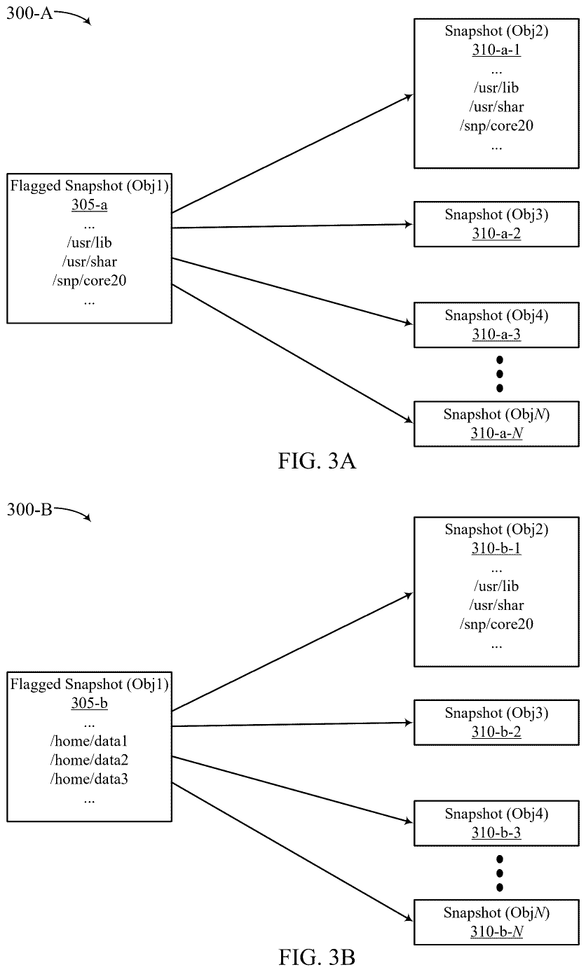

Comparing snapshots across computing objects, computing similarity scores, and detecting false positives are described in more detail herein, including with reference to FIGS. 3A through 5B.

At 235, an alert may be sent (e.g., to a customer that manages the computing system) that an anomaly was detected within the computing system.

At 240, after the alert is sent, or in parallel with sending the alert, an encryption detection procedure may be performed. The encryption detection procedure may include calculating the entropy of the user data associated with the data changes associated with a flagged snapshot, converting the entropy feature vectors, and inputting the entropy feature vectors to a model that detects ransomware encryption.

If the encryption detection procedure detects the anomaly is associated with a ransomware attack, the encryption detection procedure may provide an indication to the alerting service, which may send an alert (e.g., a high priority alert) to the user that the DMS has confirmed the anomaly is associated with undesirable behavior. In some examples, if the encryption detection procedure detects the anomaly is not associated with a ransomware attack, the encryption detection procedure may provide an indication to the alerting service, which may send an alert to the user that a previously indicated anomaly was a false positive.

Aspects of the flowchart 200 may be implemented by a controller, among other components. Additionally, or alternatively, aspects of the flowchart 200 may be implemented as instructions stored in memory (e.g., firmware stored in a memory coupled with a controller). For example, the instructions, when executed by a controller, may cause the controller to perform the operations of the flowchart 200.

One or more of the operations described in the flowchart 200 may be performed earlier or later, omitted, replaced, supplemented, or combined with another operation. Also, additional operations described herein may replace, supplement or be combined with one or more of the operations described in the flowchart 200.

FIG. 3A shows an example of a diagram for anomaly characterization using snapshots in accordance with examples as disclosed herein.

The diagram 300-a depicts a set of snapshots that are compared with one another to detect whether a detected anomaly is a false positive. In some examples, one or more snapshots of one or more computing objects in a computing system that have been flagged as anomalous (e.g., the flagged snapshot 305-a) may be compared with the snapshots of the other computing objects in the computing system (e.g., the first snapshot 310-a-1 through the Nth snapshot 310-a-N). In some examples, one or more of the snapshots of the other computing objects may have also been flagged as anomalous by the anomaly detection procedure.

In some examples, the flagged snapshot 305-a, which may be associated with a first computing object, may be compared with each of the snapshots of the other computing objects. In some examples, the file changes to the first computing object captured by the flagged snapshot 305-a may be similar to the file changes to the second computing object captured by the first snapshot 310-a-1—e.g., if the computing objects are of a same or similar type and a similar upgrade procedure is applied to both of the computing objects. In some examples, the file changes are captured within the snapshots as file paths, which may be compared with one another to determine similarities between the snapshots. In other examples, the file changes are captured as hashes that can be compared with one another to determine similarities between the snapshots. The procedure for comparing and determining similarity between snapshots is described in more detail herein, including with reference to the operations described at 220 through 230 of FIG. 2.

FIG. 3B shows an example of a diagram for anomaly characterization using snapshots in accordance with examples as disclosed herein.

The diagram 300-b depicts a set of snapshots that are compared with one another to detect whether a detected anomaly is a false positive. In some examples, one or more snapshots of one or more computing objects in a computing system that have been flagged as anomalous (e.g., the flagged snapshot 305-b) may be compared with the snapshots of the other computing objects in the computing system (e.g., the first snapshot 310-b-1 through the Nth snapshot 310-b-N). In some examples, one or more of the snapshots of the other computing objects may have also been flagged as anomalous by the anomaly detection procedure.

In some examples, the flagged snapshot 305-b, which may be associated with a first computing object, may be compared with each of the snapshots of the other computing objects. In some examples, the file changes to the first computing object captured by the flagged snapshot 305-b may be different than the file changes to the second computing object captured by the first snapshot 310-b-1. In such cases, the DMS may identify the detected anomaly as an actual anomaly that warrants further investigation. The procedure for comparing and determining similarity between snapshots is described in more detail herein, including with reference to FIGS. 2 and 3A.

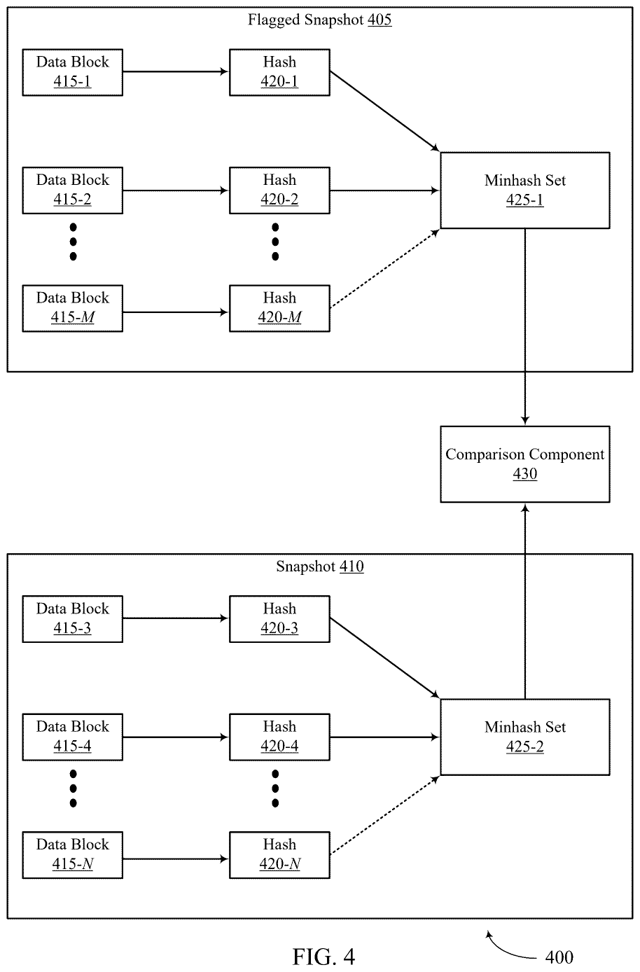

FIG. 4 shows an example of a diagram for anomaly characterization using snapshots in accordance with examples as disclosed herein.

The diagram 400 depicts two snapshots for two computing objects (of multiple snapshots for multiple computing objects) that are compared within one another as part of detecting whether a detected anomaly in a flagged snapshot (e.g., the flagged snapshot 405) is a false positive.

The flagged snapshot 405 may include a set of hashes (e.g., the first hash 420-1 through the Mth hash 420-M) that are associated with a set of data blocks (e.g., the first data block 415-1 through the Mth data block 415-M) having changes captured by the flagged snapshot 405. In some examples, the hashes may be computed for the data blocks by applying a hashing algorithm (such as a Secure Hash Algorithm (SHA)-256) to the data stored by the data blocks. In some examples, the hashes may be computed prior to detecting the anomaly in the flagged snapshot. In other examples, the hashes may be computed after the anomaly is detected—e.g., in preparation for the comparison. In some examples, a subset of the hashes (e.g., one hundred of the hashes) may be included in the first minhash set 425-1. In some examples, the subset of the hashes are the one hundred lowest hash values.

The snapshot 410 may similarly include a set of hashes (e.g., the third hash 420-3 through the Nth hash 420-N) that are associated with a set of data blocks (e.g., the third data block 415-3 through the Nth data block 415-N). Also, the set of hashes may similarly be included in the second minhash set 425-2.

In some examples, the first minhash set 425-1 and the second minhash set 425-2 may be provided to the comparison component. The comparison component 430 may determine a similarity between the first minhash set 425-1 and the second minhash set 425-2 (e.g., by computing a similarity score), as similarly described herein, including with reference to the operations described at 225 and 230 of FIG. 2. In some examples, the hashes in the flagged snapshot 405 and the hashes in the snapshot 410 may be provided directly to the comparison component 430. In such cases, the comparison component 430 may similarly determine similarities between the full hash set. By processing minhash sets (e.g., rather than full hash sets), a processing load associated with the comparison may be reduced.

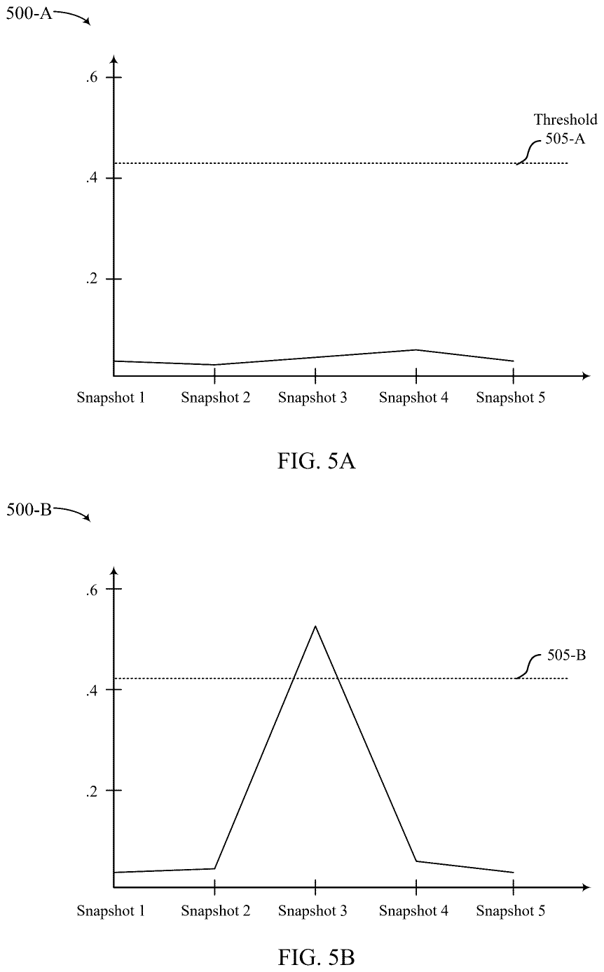

FIG. 5A shows an example of a diagram for anomaly characterization using snapshots in accordance with examples as disclosed herein.

The diagram 500-a depicts a graph of calculated similarity scores between a flagged snapshot and five other snapshots. The diagram 500-a depicts a scenario where none of the snapshots compared with the flagged snapshot are identified as being sufficiently similar to the flagged snapshot to exceed the similarity score threshold 505-a. In such cases, the DMS may determine that the anomaly is an actual anomaly such that the anomaly should be reported to the user for further investigation and an encryption detection procedure should be performed.

In some examples, the similarity score threshold 505-a is configurable (e.g., to have a value between 0.1 and 1). For example, the similarity score threshold 505-a may be configured to be higher to avoid improperly flagging an actual anomaly as a false positive (which may result in more false positives to be reported to a customer). Or the similarity score threshold 505-a may be configured to be lower to reduce the number of alerts sent to a customer (which may result in an actual anomaly being identified as a false positive). In some examples, the similarity score threshold 505-a is set at the lowest position at which the rate of actual anomalies being identified as false positive is expected to be below a threshold (e.g., less than 1/10,000).

FIG. 5B shows an example of a diagram for anomaly characterization using snapshots in accordance with examples as disclosed herein.

The diagram 500-b depicts a graph of calculated similarity scores between a flagged snapshot and five other snapshots. The diagram 500-b depicts a scenario where one of the snapshots compared with the flagged snapshot is identified as being sufficiently similar to the flagged snapshot to exceed the similarity score threshold 505-b. In such cases, the DMS may determine that the anomaly is a false positive and may refrain from reporting the anomaly to the customer. In some examples, the DMS may further refrain from performing an encryption detection procedure.

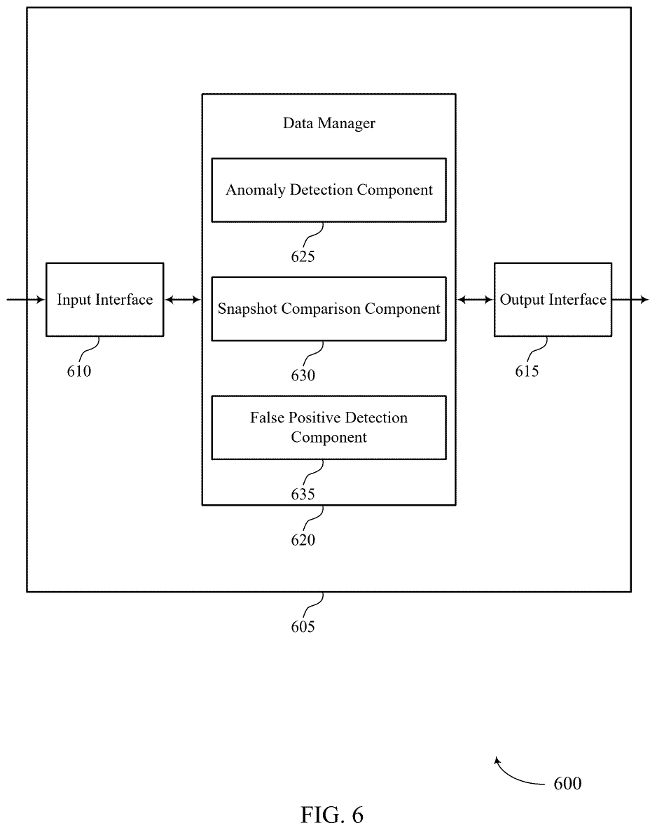

FIG. 6 shows a block diagram 600 of a system 605 that supports anomaly characterization using snapshots in accordance with aspects of the present disclosure. In some examples, the system 605 may be an example of aspects of one or more components described with reference to FIG. 1, such as a DMS 110. The system 605 may include an input interface 610, an output interface 615, and a data manager 620. The system 605 may also include one or more processors. Each of these components may be in communication with one another (e.g., via one or more buses, communications links, communications interfaces, or any combination thereof).

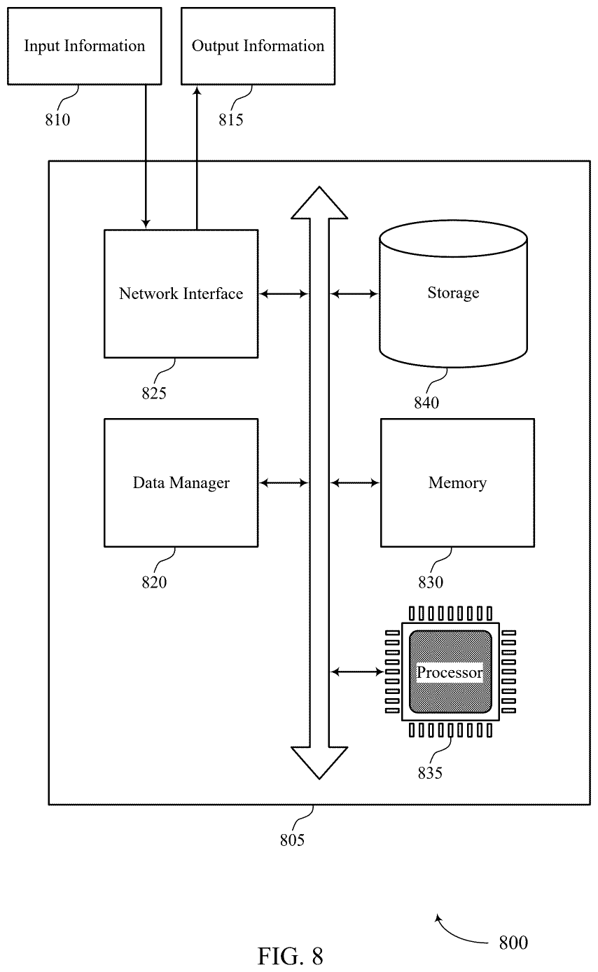

The input interface 610 may manage input signaling for the system 605. For example, the input interface 610 may receive input signaling (e.g., messages, packets, data, instructions, commands, or any other form of encoded information) from other systems or devices. The input interface 610 may send signaling corresponding to (e.g., representative of or otherwise based on) such input signaling to other components of the system 605 for processing. For example, the input interface 610 may transmit such corresponding signaling to the data manager 620 to support anomaly characterization using snapshots. In some cases, the input interface 610 may be a component of a network interface 825 as described with reference to FIG. 8.

The output interface 615 may manage output signaling for the system 605. For example, the output interface 615 may receive signaling from other components of the system 605, such as the data manager 620, and may transmit such output signaling corresponding to (e.g., representative of or otherwise based on) such signaling to other systems or devices. In some cases, the output interface 615 may be a component of a network interface 825 as described with reference to FIG. 8.

For example, the data manager 620 may include an anomaly detection component 625, a snapshot comparison component 630, a false positive detection component 635, or any combination thereof. In some examples, the data manager 620, or various components thereof, may be configured to perform various operations (e.g., receiving, monitoring, transmitting) using or otherwise in cooperation with the input interface 610, the output interface 615, or both. For example, the data manager 620 may receive information from the input interface 610, send information to the output interface 615, or be integrated in combination with the input interface 610, the output interface 615, or both to receive information, transmit information, or perform various other operations as described herein.

The anomaly detection component 625 may be configured as or otherwise support a means for detecting, based on an analysis of one or more snapshots of computing objects within a computing system, an anomaly in data of the computing system, where the computing system includes a set of multiple computing objects. The snapshot comparison component 630 may be configured as or otherwise support a means for comparing, based on detecting the anomaly, first data associated with a first snapshot of a first computing object of the set of multiple computing objects with second data associated with a second snapshot of a second computing object of the set of multiple computing objects. The false positive detection component 635 may be configured as or otherwise support a means for determining, based on comparing the first data with the second data, whether the anomaly is associated with desirable activity in the computing system.

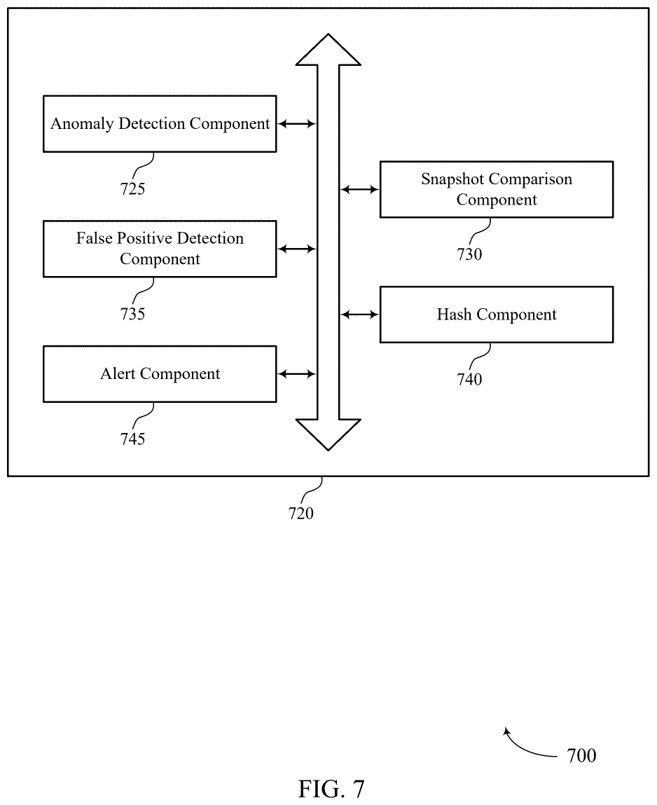

FIG. 7 shows a block diagram 700 of a data manager 720 that supports anomaly characterization using snapshots in accordance with aspects of the present disclosure. The data manager 720 may be an example of aspects of a data manager or a data manager 620, or both, as described herein. The data manager 720, or various components thereof, may be an example of means for performing various aspects of anomaly characterization using snapshots as described herein. For example, the data manager 720 may include an anomaly detection component 725, a snapshot comparison component 730, a false positive detection component 735, a hash component 740, an alert component 745, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The anomaly detection component 725 may be configured as or otherwise support a means for detecting, based on an analysis of one or more snapshots of computing objects within a computing system, an anomaly in data of the computing system, where the computing system includes a set of multiple computing objects. The snapshot comparison component 730 may be configured as or otherwise support a means for comparing, based on detecting the anomaly, first data associated with a first snapshot of a first computing object of the set of multiple computing objects with second data associated with a second snapshot of a second computing object of the set of multiple computing objects. The false positive detection component 735 may be configured as or otherwise support a means for determining, based on comparing the first data with the second data, whether the anomaly is associated with desirable activity in the computing system.

In some examples, determining whether the anomaly is associated with desirable activity includes determining that the anomaly is associated with undesirable activity based on the first data and the second data being associated with a similarity score that is less than a similarity score threshold.

In some examples, determining whether the anomaly is associated with desirable activity includes determining that the anomaly is associated with desirable activity based on the first data and the second data being associated with a similarity score that is greater than or equal to a similarity score threshold.

In some examples, the hash component 740 may be configured as or otherwise support a means for computing, based on detecting the anomaly, a first minhash set for the first data and a second minhash set for the second data.

In some examples, the first data includes the first minhash set, the second data includes the second minhash set, and comparing the first data with the second data includes determining a similarity between the first minhash set and the second minhash set.

In some examples, the first minhash set is a subset of a first set of multiple hashes computed for the first data, and the second minhash set is a subset of a second set of multiple hashes computed for the second data, the first minhash set and the second minhash set both including a same quantity of hashes.

In some examples, the first minhash set includes a first quantity of hashes, the second minhash set includes a second quantity of hashes, the first set of multiple hashes includes a third quantity of hashes, the third quantity being greater than the first quantity and the second quantity, and the second set of multiple hashes includes a fourth quantity of hashes, the fourth quantity being greater than the first quantity and the second quantity.

In some examples, the first minhash set includes a first set of hashes from among the first set of multiple hashes, the first set of hashes having lowest respective values from among the first set of multiple hashes, and the second minhash set includes a second set of hashes from among the second set of multiple hashes, the second set of hashes having lowest respective values from among the second set of multiple hashes.

In some examples, the hash component 740 may be configured as or otherwise support a means for computing the first set of multiple hashes for the first data and the second set of multiple hashes for the second data prior to the anomaly being detected.

In some examples, the alert component 745 may be configured as or otherwise support a means for refraining from sending an alert that the anomaly was detected based on the first data and the second data having a similarity score that is greater than or equal to a similarity score threshold.

In some examples, the first data includes first metadata representing first changes to a file system of the first computing object, the second data includes second metadata representing second changes to a file system of the second computing object, and comparing the first data with the second data includes determining a similarity between the first metadata and the second metadata.

In some examples, detecting the anomaly includes detecting a first anomaly associated with the first data associated with the first snapshot, a second anomaly associated with the second data associated with the second snapshot, a third anomaly associated with third data associated with a third snapshot of a third computing object of the set of multiple computing objects, or any combination thereof.

In some examples, the set of multiple computing objects include a set of multiple types of computing objects. In some examples, the first computing object and the second computing object are both of a first type of computing object from among the set of multiple types of computing objects. In some examples, the first computing object is of a first type of computing object from among the plurality of types of computing objects and the second computing object is of a second type of computing object from among the plurality of types of computing objects, the second type of computing object being the same as or similar to the first type of computing object.

FIG. 8 shows a block diagram 800 of a system 805 that supports anomaly characterization using snapshots in accordance with aspects of the present disclosure. The system 805 may be an example of or include components of a system 605 as described herein. The system 805 may include components for data management, including components such as a data manager 820, an input information 810, an output information 815, a network interface 825, at least one memory 830, at least one processor 835, and a storage 840. These components may be in electronic communication or otherwise coupled with each other (e.g., operatively, communicatively, functionally, electronically, electrically; via one or more buses, communications links, communications interfaces, or any combination thereof). Additionally, the components of the system 805 may include corresponding physical components or may be implemented as corresponding virtual components (e.g., components of one or more virtual machines). In some examples, the system 805 may be an example of aspects of one or more components described with reference to FIG. 1, such as a DMS 110.

The network interface 825 may enable the system 805 to exchange information (e.g., input information 810, output information 815, or both) with other systems or devices (not shown). For example, the network interface 825 may enable the system 805 to connect to a network (e.g., a network 120 as described herein). The network interface 825 may include one or more wireless network interfaces, one or more wired network interfaces, or any combination thereof. In some examples, the network interface 825 may be an example of may be an example of aspects of one or more components described with reference to FIG. 1, such as one or more network interfaces 165.

Memory 830 may include RAM, ROM, or both. The memory 830 may store computer-readable, computer-executable software including instructions that, when executed, cause the processor 835 to perform various functions described herein. In some cases, the memory 830 may contain, among other things, a basic input/output system (BIOS), which may control basic hardware or software operation such as the interaction with peripheral components or devices. In some cases, the memory 830 may be an example of aspects of one or more components described with reference to FIG. 1, such as one or more memories 175.

The processor 835 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 835 may be configured to execute computer-readable instructions stored in a memory 830 to perform various functions (e.g., functions or tasks supporting anomaly characterization using snapshots). Though a single processor 835 is depicted in the example of FIG. 8, it is to be understood that the system 805 may include any quantity of one or more of processors 835 and that a group of processors 835 may collectively perform one or more functions ascribed herein to a processor, such as the processor 835. In some cases, the processor 835 may be an example of aspects of one or more components described with reference to FIG. 1, such as one or more processors 170.

Storage 840 may be configured to store data that is generated, processed, stored, or otherwise used by the system 805. In some cases, the storage 840 may include one or more HDDs, one or more SDDs, or both. In some examples, the storage 840 may be an example of a single database, a distributed database, multiple distributed databases, a data store, a data lake, or an emergency backup database. In some examples, the storage 840 may be an example of one or more components described with reference to FIG. 1, such as one or more network disks 180.

For example, the data manager 820 may be configured as or otherwise support a means for detecting, based on an analysis of one or more snapshots of computing objects within a computing system, an anomaly in data of the computing system, where the computing system includes a set of multiple computing objects. The data manager 820 may be configured as or otherwise support a means for comparing, based on detecting the anomaly, first data associated with a first snapshot of a first computing object of the set of multiple computing objects with second data associated with a second snapshot of a second computing object of the set of multiple computing objects. The data manager 820 may be configured as or otherwise support a means for determining, based on comparing the first data with the second data, whether the anomaly is associated with desirable activity in the computing system.

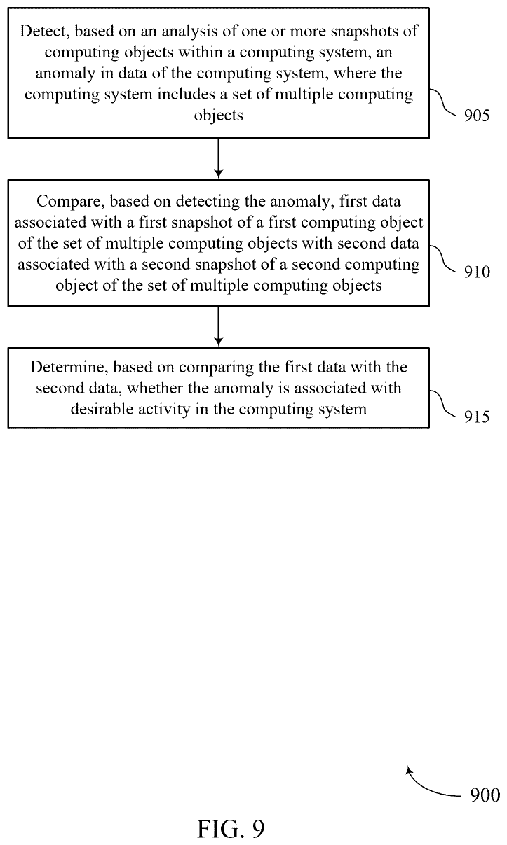

FIG. 9 shows a flowchart illustrating a method 900 that supports anomaly characterization using snapshots in accordance with aspects of the present disclosure. The operations of the method 900 may be implemented by a DMS or its components as described herein. For example, the operations of the method 900 may be performed by a DMS as described with reference to FIGS. 1 through 8. In some examples, a DMS may execute a set of instructions to control the functional elements of the DMS to perform the described functions. Additionally, or alternatively, the DMS may perform aspects of the described functions using special-purpose hardware.

At 905, the method may include detecting, based on an analysis of one or more snapshots of computing objects within a computing system, an anomaly in data of the computing system, where the computing system includes a set of multiple computing objects. The operations of 905 may be performed in accordance with examples as disclosed herein. In some examples, aspects of the operations of 905 may be performed by an anomaly detection component 725 as described with reference to FIG. 7.

At 910, the method may include comparing, based on detecting the anomaly, first data associated with a first snapshot of a first computing object of the set of multiple computing objects with second data associated with a second snapshot of a second computing object of the set of multiple computing objects. The operations of 910 may be performed in accordance with examples as disclosed herein. In some examples, aspects of the operations of 910 may be performed by a snapshot comparison component 730 as described with reference to FIG. 7.

At 915, the method may include determining, based on comparing the first data with the second data, whether the anomaly is associated with desirable activity in the computing system. The operations of 915 may be performed in accordance with examples as disclosed herein. In some examples, aspects of the operations of 915 may be performed by a false positive detection component 735 as described with reference to FIG. 7.

The following provides an overview of aspects of the present disclosure:

Aspect 1: A method, comprising: detecting, based at least in part on an analysis of one or more snapshots of computing objects within a computing system, an anomaly in data of the computing system, wherein the computing system comprises a plurality of computing objects; comparing, based at least in part on detecting the anomaly, first data associated with a first snapshot of a first computing object of the plurality of computing objects with second data associated with a second snapshot of a second computing object of the plurality of computing objects; and determining, based at least in part on comparing the first data with the second data, whether the anomaly is associated with desirable activity in the computing system.

Aspect 2: The method of aspect 1, wherein determining whether the anomaly is associated with desirable activity comprises determining that the anomaly is associated with undesirable activity based at least in part on the first data and the second data being associated with a similarity score that is less than a similarity score threshold.

Aspect 3: The method of any of aspects 1 through 2, wherein determining whether the anomaly is associated with desirable activity comprises determining that the anomaly is associated with desirable activity based at least in part on the first data and the second data being associated with a similarity score that is greater than or equal to a similarity score threshold.

Aspect 4: The method of any of aspects 1 through 3, further comprising: computing, based at least in part on detecting the anomaly, a first minhash set for the first data and a second minhash set for the second data.

Aspect 5: The method of aspect 4, wherein the first data comprises the first minhash set, the second data comprises the second minhash set, and comparing the first data with the second data comprises determining a similarity between the first minhash set and the second minhash set.

Aspect 6: The method of any of aspects 4 through 5, wherein the first minhash set is a subset of a first plurality of hashes computed for the first data, and the second minhash set is a subset of a second plurality of hashes computed for the second data, the first minhash set and the second minhash set both comprising a same quantity of hashes.

Aspect 7: The method of aspect 6, wherein the first minhash set comprises a first quantity of hashes, the second minhash set comprises a second quantity of hashes, the first plurality of hashes comprises a third quantity of hashes, the third quantity being greater than the first quantity and the second quantity, and the second plurality of hashes comprises a fourth quantity of hashes, the fourth quantity being greater than the first quantity and the second quantity.

Aspect 8: The method of any of aspects 6 through 7, wherein the first minhash set comprises a first set of hashes from among the first plurality of hashes, the first set of hashes having lowest respective values from among the first plurality of hashes, and the second minhash set comprises a second set of hashes from among the second plurality of hashes, the second set of hashes having lowest respective values from among the second plurality of hashes.

Aspect 9: The method of any of aspects 6 through 8, further comprising: computing the first plurality of hashes for the first data and the second plurality of hashes for the second data prior to the anomaly being detected.

Aspect 10: The method of any of aspects 1 through 9, further comprising: refraining from sending an alert that the anomaly was detected based at least in part on the first data and the second data having a similarity score that is greater than or equal to a similarity score threshold.

Aspect 11: The method of any of aspects 1 through 10, wherein the first data comprises first metadata representing first changes to a file system of the first computing object, the second data comprises second metadata representing second changes to a file system of the second computing object, and comparing the first data with the second data comprises determining a similarity between the first metadata and the second metadata.

Aspect 12: The method of any of aspects 1 through 11, wherein detecting the anomaly comprises detecting a first anomaly associated with the first data associated with the first snapshot, a second anomaly associated with the second data associated with the second snapshot, a third anomaly associated with third data associated with a third snapshot of a third computing object of the plurality of computing objects, or any combination thereof.

Aspect 13: An apparatus comprising one or more memories storing processor-executable code, and one or more processors coupled with the one or more memories and individually or collectively operable to execute the code to cause the apparatus to perform a method of any of aspects 1 through 12.

Aspect 14: An apparatus comprising at least one means for performing a method of any of aspects 1 through 12.

Aspect 15: A non-transitory computer-readable medium storing code the code comprising instructions executable by one or more processors to perform a method of any of aspects 1 through 12.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
detecting, based at least in part on an analysis of one or more snapshots of computing objects within a computing system, an anomaly in data of the computing system, wherein the computing system comprises a plurality of computing objects;
comparing, based at least in part on detecting the anomaly, first data associated with a first snapshot of a first computing object of the plurality of computing objects with second data associated with a second snapshot of a second computing object of the plurality of computing objects; and
determining, based at least in part on comparing the first data with the second data, whether the anomaly is associated with desirable activity in the computing system.

2. The method of claim 1, wherein determining whether the anomaly is associated with desirable activity comprises:
determining that the anomaly is associated with undesirable activity based at least in part on the first data and the second data being associated with a similarity score that is less than a similarity score threshold.

3. The method of claim 1, wherein determining whether the anomaly is associated with desirable activity comprises:
determining that the anomaly is associated with desirable activity based at least in part on the first data and the second data being associated with a similarity score that is greater than or equal to a similarity score threshold.

4. The method of claim 1, further comprising:
computing, based at least in part on detecting the anomaly, a first minhash set for the first data and a second minhash set for the second data.

5. The method of claim 4, wherein:
the first data comprises the first minhash set,
the second data comprises the second minhash set, and
comparing the first data with the second data comprises determining a similarity between the first minhash set and the second minhash set.

6. The method of claim 4, wherein:
the first minhash set is a subset of a first plurality of hashes computed for the first data, and
the second minhash set is a subset of a second plurality of hashes computed for the second data, the first minhash set and the second minhash set both comprising a same quantity of hashes.

7. The method of claim 6, wherein:
the first minhash set comprises a first quantity of hashes;
the second minhash set comprises a second quantity of hashes;
the first plurality of hashes comprises a third quantity of hashes, the third quantity being greater than the first quantity and the second quantity; and
the second plurality of hashes comprises a fourth quantity of hashes, the fourth quantity being greater than the first quantity and the second quantity.

8. The method of claim 6, wherein:
the first minhash set comprises a first set of hashes from among the first plurality of hashes, the first set of hashes having lowest respective values from among the first plurality of hashes, and
the second minhash set comprises a second set of hashes from among the second plurality of hashes, the second set of hashes having lowest respective values from among the second plurality of hashes.

9. The method of claim 6, further comprising:
computing the first plurality of hashes for the first data and the second plurality of hashes for the second data prior to the anomaly being detected.

10. The method of claim 1, further comprising:
refraining from sending an alert that the anomaly was detected based at least in part on the first data and the second data having a similarity score that is greater than or equal to a similarity score threshold.

11. The method of claim 1, wherein:
the first data comprises first metadata representing first changes to a file system of the first computing object,
the second data comprises second metadata representing second changes to a file system of the second computing object, and
comparing the first data with the second data comprises determining a similarity between the first metadata and the second metadata.

12. The method of claim 1, wherein detecting the anomaly comprises:
detecting a first anomaly associated with the first data associated with the first snapshot, a second anomaly associated with the second data associated with the second snapshot, a third anomaly associated with third data associated with a third snapshot of a third computing object of the plurality of computing objects, or any combination thereof.

13. A data management system, comprising:
one or more memories; and
one or more processors, wherein the one or more memories store code comprising instructions executable, individually or collectively, by the one or more processors to cause the data management system to:
detect, based at least in part on an analysis of one or more snapshots of computing objects within a computing system, an anomaly in data of the computing system, wherein the computing system comprises a plurality of computing objects;
compare, based at least in part on detecting the anomaly, first data associated with a first snapshot of a first computing object of the plurality of computing objects with second data associated with a second snapshot of a second computing object of the plurality of computing objects; and
determine, based at least in part on comparing the first data with the second data, whether the anomaly is associated with desirable activity in the computing system.

14. The data management system of claim 13, wherein, to determine whether the anomaly is associated with desirable activity, the instructions are executable by the one or more processors to cause the data management system to:
determine that the anomaly is associated with undesirable activity based at least in part on the first data and the second data being associated with a similarity score that is less than a similarity score threshold.

15. The data management system of claim 13, wherein, to determine whether the anomaly is associated with desirable activity, the instructions are executable by the one or more processors to cause the data management system to:
determine that the anomaly is associated with desirable activity based at least in part on the first data and the second data being associated with a similarity score that is greater than or equal to a similarity score threshold.

16. The data management system of claim 13, wherein the instructions are further executable by the one or more processors to cause the data management system to:
compute, based at least in part on detecting the anomaly, a first minhash set for the first data and a second minhash set for the second data.

17. A non-transitory, computer-readable medium storing code that comprises instructions that are executable, individually or collectively, by one or more processors of a data management system to cause the data management system to:
detect, based at least in part on an analysis of one or more snapshots of computing objects within a computing system, an anomaly in data of the computing system, wherein the computing system comprises a plurality of computing objects;
compare, based at least in part on detecting the anomaly, first data associated with a first snapshot of a first computing object of the plurality of computing objects with second data associated with a second snapshot of a second computing object of the plurality of computing objects; and
determine, based at least in part on comparing the first data with the second data, whether the anomaly is associated with desirable activity in the computing system.

18. The non-transitory, computer-readable medium of claim 17, wherein, to determine whether the anomaly is associated with desirable activity, the instructions are executable by the one or more processors to cause the data management system to:
determine that the anomaly is associated with undesirable activity based at least in part on the first data and the second data being associated with a similarity score that is less than a similarity score threshold.

19. The non-transitory, computer-readable medium of claim 17, wherein, to determine whether the anomaly is associated with desirable activity, the instructions are executable by the one or more processors to cause the data management system to:
determine that the anomaly is associated with desirable activity based at least in part on the first data and the second data being associated with a similarity score that is greater than or equal to a similarity score threshold.

20. The non-transitory, computer-readable medium of claim 17, wherein the instructions are further executable by the one or more processors to cause the data management system to:
compute, based at least in part on detecting the anomaly, a first minhash set for the first data and a second minhash set for the second data.
